(19) United States
(12) Patent Application Publication
(10) Pub. No.: US 2008/0130947 A1
(43) Pub. Date: Jun. 5, 2008

(54) ADDRESS DISAMBIGUATION FOR MAIL-PIECE ROUTING

(75) Inventors: David Justin Ross, Redmond, WA (US); Richard C. Teudt, Bothell, WA (US)

Correspondence Address: Stolowitz Ford Cowger LLP, 621 SW Morrison St, Suite 600, Portland, OR, 97205, US

(73) Assignee: RAF Technology, Inc., Redmond, WA (US)

(21) Appl. No.: 12/015,471

(22) Filed: Jan. 16, 2008

Related U.S. Application Data
(62) Division of application No. 10/462,377, filed on Jun. 16, 2003.
(60) Provisional application No. 60/389,760, filed on Jun. 17, 2002.

(51) Int. Cl. G06K 9/00

(52) U.S. Cl. 382/101

(57) ABSTRACT

Improvements are disclosed for automatically routing items, such as mail-piece items (FIG. 2), in support of efficiently and correctly delivering them to an intended destination. A destination address is read by a recognizer (12) but it may be too ambiguous (14,18) initially for routing the piece. The addressee name is also read (24), and the recognizer data is provided to a directory (26) that accesses a name+address database (28). The addressee name is used to disambiguate the recognizer address data (26,30) and thereby properly route the piece (32). In addition, the name+address directory (42,44) can detect incorrect address data (42,50), and notwithstanding the incorrect address, correctly routing the item (52,46) to the intended addressee based on the recognized addressee name (40).

### RELATED APPLICATIONS

This application claims priority from pending U.S. patent application Ser. No. 10/462,377, filed Jun. 16, 2003 and U.S. Provisional Application No. 60/389,760 filed Jun. 17, 2002 both of which are incorporated herein by this reference.

### COPYRIGHT NOTICE

© 2002-2003 RAF Technology, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

This invention pertains to methods and apparatus for automatically routing items, such as mail-piece items, in support of efficiently delivering them to an intended destination. More specifically, the present invention pertains to selecting a correct address (or disambiguating) among a set of multiple possible addresses.

The invention further pertains to detecting an incorrect address on an item, and notwithstanding the incorrect address, correctly routing the item to the intended addressee.

### BACKGROUND OF THE INVENTION

Preliminarily, it should be understood that the present invention can be used in connection with routing any item intended for physical delivery to a particular location. The item could be a letter, box, package, or any other tangible container. Indeed, an “item” for present purposes need not have a container of any kind—the item merely needs to have an address label affixed to the it that can be read, more or less, by a recognizer. We discuss mail-pieces in the following description by way of an example of an “item” and not to limit the term. Further, references herein to mail, mail-pieces and the United States Postal Service (“USPS”) are again presented merely as a convenient example to illustrate the invention. The invention can be used to advantage in other contexts such as by private package delivery couriers (Fedex, Ups, Etc.)

Mail-piece routing consists of several steps. The usual first step is to find the Region of Interest (“ROI”) on the mail piece that includes the address to which the mail is to be routed. This ROI is called the Address Block.

Once the Address Block is found, the address components within the Address Block are recognized by a software program called a “recognizer,” which can be designed to recognize either machine print or handwriting, or both. The results of recognition are then passed to an address directory that either assigns a United States Postal Service ZIP code to the mail piece, or determines that there is insufficient information to route the mail piece. The “address directory” as used here refers to a combination of hardware and software that takes data from a recognizer, typically elements of an address, and compares that data to a database or other data source in an attempt to match that address data, which may be incomplete or ambiguous, to a record in the database.

If it finds a match, the “directory” logic then routes the piece in accordance with the now-verified address information, and it can supply missing pieces of the address from the corresponding database record if necessary. Typically, “routing” in the present context means assigning a destination ZIP code to the piece, which may then be printed on the piece, using a machine readable coding such as a bar code to support subsequent automated handling.

If there is insufficient information to route the mail piece, the mail piece is either rejected or, in some cases, it may be sent to one or more modified recognizers that attempt recognition again. Sometimes multiple recognizers are run in parallel and the results to which the directory assigns the greatest depth of sort are used to route the mail. A minimum sort assigns the well-known 5-digit ZIP code. A deeper sort provides the proper 9-digit ZIP code (“ZIP+4”). And the most detailed sort includes three additional digits, for a total of twelve, the last ones comprising a two-digit carrier route and a checksum or other error-checking digit. This can be referred to as an 11-digit ZIP code.

The directories currently used contain all the elements of the address, including street name, city name, state name, ZIP code, etc, as well as Post Office Boxes. Some contain actual street numbers (417, 423, 325, 429), while others contain only ranges of numbers (401 to 499 odd).

A problem arises when the directory cannot route the piece because the recognized address data is ambiguous. The need is to remove ambiguities remaining after recognition. If the results of recognition are ambiguous (i.e. the final character is either a ‘3’ or a ‘5’ in “12x” Main Street), then the directory must make a choice. If the directory uses actual street numbers and only one of those alternatives is an actual address (e.g. 123 Main Street exists in the USPS database, but 125 does not), then 123 will be chosen and the mail piece routed to the greatest depth of sort (i.e., to an 11 digit ZIP code). If, however, both addresses are equally valid as far as the directory can tell (i.e. either the directory has “101 to 199 odd” or has both 123 and 125 as valid addresses), then the mail piece is either rejected or routed to a lesser depth of sort (i.e. to a 5 or 9 digit ZIP code rather than to 11).

There is very little interaction between recognizers and directories in current commercial or government use. The recognizer finishes its work, hands the results off to the directory, and the directory routes the mail as best it can. A current exception to this approach is RAF's Complementary Processing, which sets different parameters in RAF's recognition if the directory did not reach full depth of sort. This requires closer interconnection of recognizer and directory than currently occurs anywhere else.

Addressee names are generally used in routing the mail in only two primary capacities. The first is mail forwarding. When a child goes to college, the desire is for his or her mail to be sent to the new address, but the rest of the family mail to continue to be delivered as previously. To accomplish this, it is necessary to read the name in order to determine whose mail to forward. A mail forwarding system is described in U.S. Pat. No. 6,292,709 B1 to Uhl et al.

U.S. Pat. No. 5,703,783 (Allen et al.) also is directed to mail forwarding. It presumes the address has already been correctly and unambiguously read off the mailpiece, and that already-clear combination is used to tell whether the address is the former address of someone who has asked for his mail to be forwarded. If so, the National Change of Address database is used to determine the new address. Once again, this is a forwarding application and there is no disambiguation of possible addresses.

The second use of names involves company or organizational names, not individual names. Sometimes, companies or organizations have their own ZIP codes (e.g. LL Bean and IRS processing centers) that are different from the ZIP code the USPS would assign to their street address. The company or organization name is therefore used to ensure the assigned ZIP (rather than the street address ZIP) is put on the envelope for routing. Neither of the two above cases involves use of name for disambiguation of two or more possible addresses.

U.S. Pat. No. 4,921,107 to Hofer discloses “a semi-automatic mail sortation system” (Abstract) to determine which of several possible mail stops to route a piece of mail to. The “ambiguous set” is the entire database of mail stops, and the name is used to determine which one of those gets the mail piece. As shown in FIG. 2, and explained in the Abstract, in that system a mail piece is presented to a live operator who keys in the first few letters of the addressee name. A processor accesses a database of names and associated mailstops, and displays a set of records consistent with the input data, i.e. a list of names (beginning with the letters keyed in) and associated mailstops. The operator then selects a record (ergo a correct mailstop) from the list and the processor routes the piece accordingly.

The system described by Hofer does not actually read (recognize) address information at all. (It is concerned with internal routing, where the address on every piece is the same.) Rather, it merely displays database records selected in response to the operator input of name characters. Mailstop information does not appear on the envelope at all in that scenario. Thus Hofer does not teach capturing address candidates and using addressee name information to automatically disambiguate among those candidates.

The need remains for methods and systems to resolve or disambiguate address information in a routing system when the recognizer(s) and directories cannot determine a single, correct destination but instead determine a plurality of candidate solutions.

### SUMMARY OF THE INVENTION

The current invention proposes the use of name or other non-destination-address information from the mail piece for purposes of disambiguating between two or more possible addresses. Heretofore, the USPS for example has generally limited its systems to using names for the two above purposes, so little or no work has been done to leverage names or other non-address information for other purposes. In addition, heretofore those who recognize what is written or printed on the mail, and those who provide routing information, are generally different companies with different capabilities. This is particularly true for machine print recognition. Even in the case of handwriting recognition, which is generally more directory-driven, the USPS is the source of the directories, and they supply only address information, not name or other data.

While this invention proposes the use of any non-destination-address information on the envelope for distinguishing among ambiguous alternative addresses, name is particularly useful for two reasons. First, names are generally found by the address block locators, since they are very often situated immediately above the first address line. Therefore they are immediately available to recognizers.

Second, there are commercially available databases of names plus addresses. Such are available, for example, from RAF Technology, Inc. of Redmond, Wash., assignee of the present invention. These commercial databases are generally used either for generating marketing mailing lists or for authenticating people who claim to live at a particular address. This invention proposes leveraging such databases for the new purpose of disambiguating between two or more possible addresses for the purpose of routing the mail, and for reducing the incidence of mail-piece misrouting.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified flow diagram illustrating a routing methodology consistent with the present invention.

FIG. 2 illustrates a mail piece in which the destination address is partially obscured and consequently ambiguous.

FIG. 3 illustrates a mail piece in which the destination address is fully visible but a portion of it is ambiguous.

FIG. 4 is a simplified flow diagram illustrating a routing methodology for reduced misrouting consistent with the present invention.

### DETAILED DESCRIPTION OF PREFERRED EMBODIMENTS

The use of name or other non-destination-address information on the envelope serves two complementary purposes, both of which are aspects of the present invention. First is the purpose of disambiguating two or more addresses. Second is reduction in error in routing the mail (e.g. when the mail piece is actually misaddressed or when the address is misread by the recognizer).

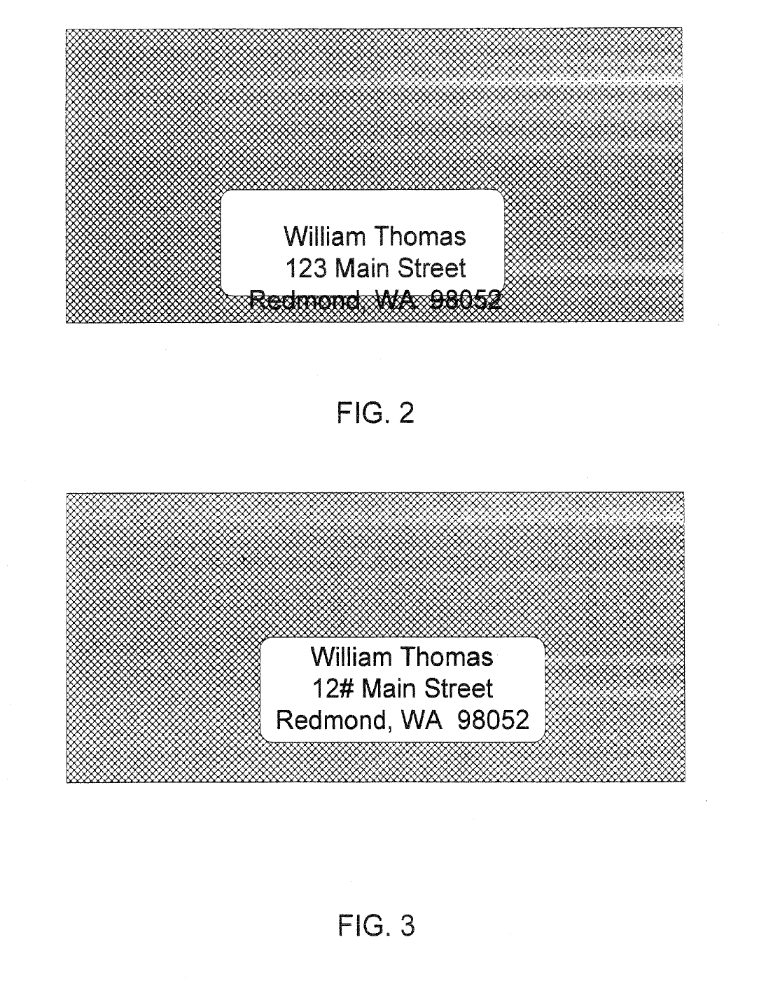

Ambiguity may arise in reading a mail piece from several causes. For the purposes of example in this invention, consider two of them. A first example is illustrated in FIG. 2. Here, a mail piece has a glassine window on the envelope, within which the address is supposed to be visible. The address is, for the purpose of this example, 123 Main Street, Redmond, Wash. 98052. Unfortunately, in this example, the sheet inside the envelope has slipped downward so that the last line, saying “Redmond, Wash. 98052”, is obscured.

Fortunately, above the line which contains 123 Main Street, the name of the addressee is visible, “William Thomas.” The present invention reads “William Thomas, 123 Main Street” and attempts to route the mail piece. It is quickly determined that 123 Main Street is an ambiguous address, there being many 123 Main Streets within the country. However, the present invention calls for consulting a directory that links names with addresses. That directory service determines that someone named “William Thomas” lives at only one of those addresses, and thus the system can correctly route the mail piece.

FIG. 3 illustrates another example where the present invention is useful. In FIG. 3, a mail piece is shown where the entire address is visible. The street number, however, contains a character (represented by the pound sign #) that is either a 3 or a 5, for example, but further determination is not possible by the recognizer. This results in either “123 Main Street” or “125 Main Street” as the recognized address data. Once again the name is available, and since “William Thomas” lives at 123 Main Street, the mail piece can be correctly routed.

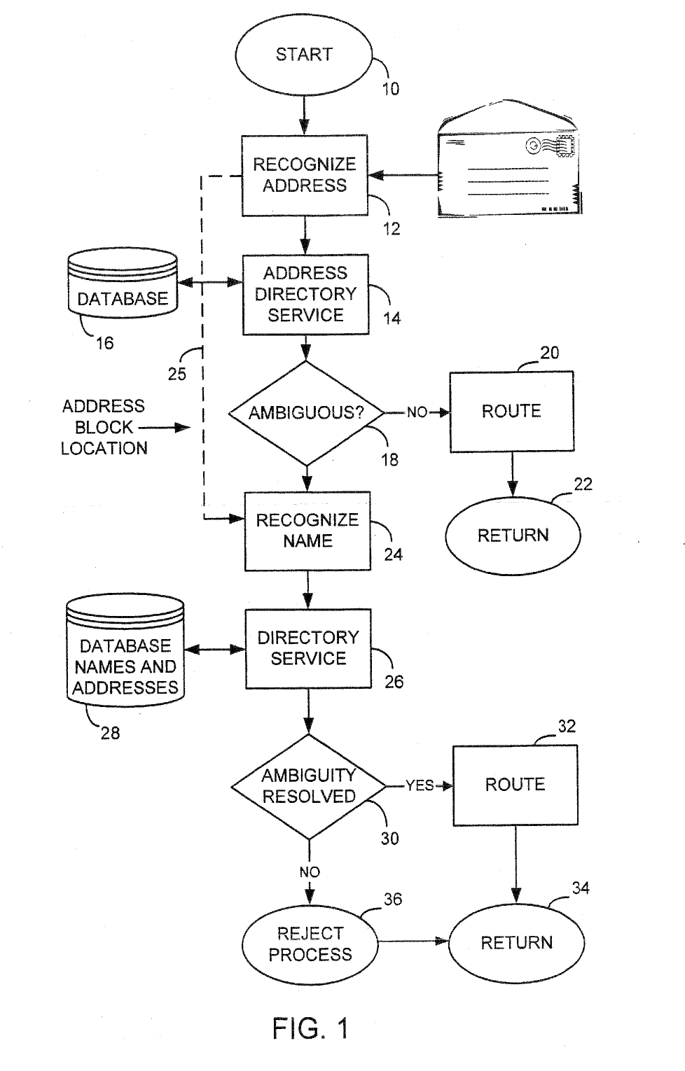

FIG. 1 is a simplified flow diagram illustrating a routing methodology consistent with the present invention. In FIG. 1, a flow diagram illustrates the methodology of the present invention, beginning at the starting node 10. As is known, mail piece routing typically begins by scanning an image of the item, and then searching for a region of interest on the piece that includes the address to which the mail is to be routed. This region of interest is typically called the address block as noted earlier. Once the address block is found, address components within the address block are recognized by a suitable recognizer, step 12. The results of recognition are then passed to an address directory service 14, which in turn has access to a database 16 of valid addresses. For example, in the case of routing mail in the United States, database 16 would include or have access to a listing of all valid mailing addresses in the United States. Thus the address directory service 14 attempts to match the recognized address data against the contents of the database. If the address data provided by the recognizer is sufficiently unambiguous, decision 18, the piece can be routed in step 20 and the process proceeds to the next mail piece via return step 22. If the address directory lookup is ambiguous due to incomplete or inaccurate address data as provided by the recognizer, the process proceeds to step 24 for recognizing the name of the addressee. In this regard, the earlier work of the recognizer 12 in locating the address block can be used to assist in locating the addressee block. Thus the address block location indicated by dash line 25 can be provided to the name recognition step 24. Although the recognized address and recognized name steps, 12 and 24, respectively, are shown separately in FIG. 1, it may be a part of the same hardware/software recognizer system.

Following name recognition step 24, the results of the name recognition step 24 are then passed to a directory service 26, which has access to a database 28 that includes name and associated addresses. A directory service 26 attempts to resolve the address ambiguity by finding a record in the database 28 that matches the addressee (or other non-address data) provided by a recognizer. If the ambiguity is successfully resolved, test 30, the mail piece is routed, step 32, and the process returns, step 34. If the ambiguity still cannot be resolved, a reject process 36 is invoked, which may include repeated attempts at recognition, manual intervention, or simply routing the item to a lesser depth of sort.

Next we describe a use of the invention for reduction of errors in mail routing. This is especially important, as misrouting a mail piece is quite costly to the U.S. Postal Service (or any other courier). Assume the recognizer determines that the address is “125 Main Street, Redmond, Wash. 98052.” The address directory confirms that that is a valid USPS address. In accordance with the prior art, the mail piece therefore would be routed to that address, there currently being no way to detect the address actually is wrong.

In accordance with the present invention, the routing system checks the name (also readable) against the address. Since “William Thomas” lives at 123 Main Street, and not at 125 Main Street in Redmond, Wash., the sorter can stop the mail piece from going to the wrong address. Depending on the needs of the U.S. Postal Service or commercial sorter, the mail piece can then either be routed to 123 Main Street, or sorted to a lesser depth of sort.

Thus the present invention works by linking address information with additional information on an address-by-address manner, such that the additional information provides further data on what the correct address is (or at least on what it is not). Although name has the widest (and easiest) application, other non-Destination-Address information on the mail piece can be used in the same way by creating directories that link the information with particular addresses.

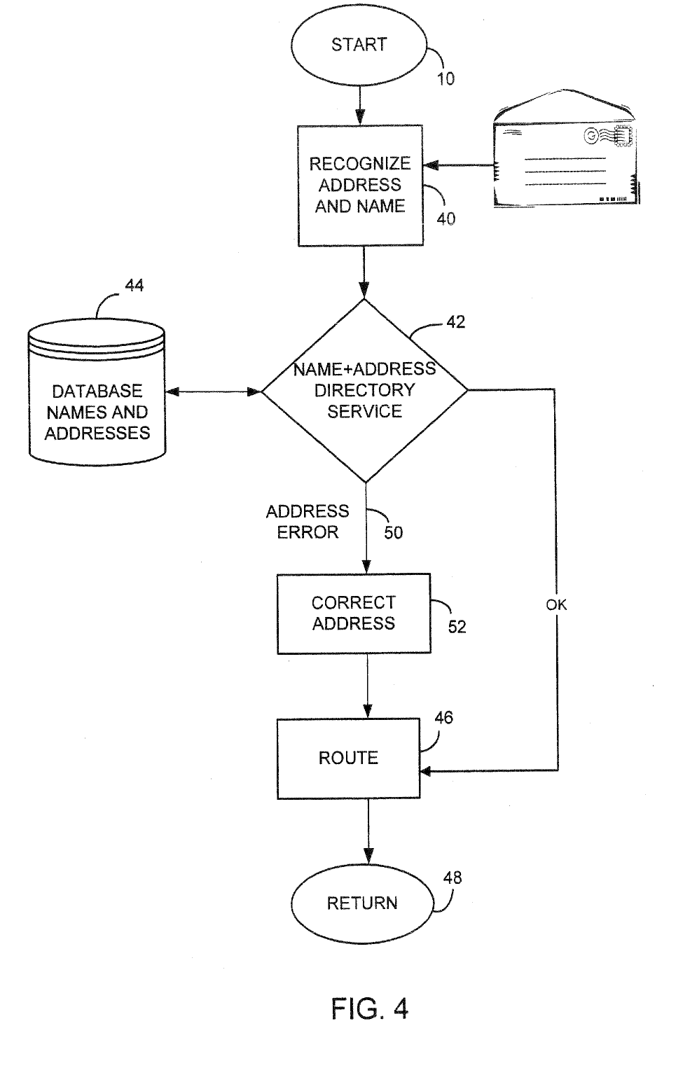

FIG. 4 is a simplified flow diagram illustrating a process for reducing routing errors that arise from incorrect addresses. In other words, even if the address is visible and is flawlessly “recognized,” it may simply be incorrect because the sender was misinformed or made a mistake. Referring now to FIG. 4, the process again begins at step 10 where recognizer attempts to locate and “read” the address and addressee name information, step 40, from a mail piece. The recognizer results, including address and name data, are then passed to a directory service 42, which has access to a database 44 of names and associated addresses. If the directory 42 can identify a record in database 44 that matches the recognizer results, it proceeds to routing the mail piece in step 46, followed by a return step 48. If the directory 42 finds a record in database 44 that matches the addressee (or other non-address data), but the address in database 44 associated with that name does not match the recognizer results, an address error is detected, path 50. The system then corrects the address by substituting the correct address provided by the database 44, in step 52, and then proceeds to routing the piece in accordance with the corrected address, step 46. This process can be used to reduce the frequency of misdirected mail pieces.

It will be obvious to those having skill in the art that many changes may be made to the details of the above-described embodiments without departing from the underlying principles of the invention. The scope of the present invention should, therefore, be determined only by the following claims.

1. A method of correctly routing an item having readable non-address data and an incorrect destination address, the method comprising the steps of:
recognizing the destination address on the item;
recognizing the non-address data on the item;
checking for correspondence between the read destination address and the read non-address data;
if the read destination address corresponds to the read non-address data, routing the item in accordance with the read destination address; and
if the read destination address does not correspond to the read non-address data, determining second destination address that does correspond to the read non-address data, and routing the item in accordance with the second destination address.

2. A method of correctly routing an item according to claim 1 and wherein said checking step comprises use of a name+address directory.

3. A method of correctly routing an item according to claim 1 wherein the non-address data comprises an addressee name.

4. A method of correctly routing an item according to claim 3 wherein the addressee name is the name of a person or family.

5. A method of correctly routing an item according to claim 3 and wherein said item is a letter or package.
